(19) United States
(12) Patent Application Publication
(10) Pub. No.: US 2008/0279379 A1
(43) Pub. Date: Nov. 13, 2008

(54) Conditional Access Video Signal Distribution

(76) Inventor: Marinus Carolus Mathijs Muijen, Eindhoven (NL)

Correspondence Address: SCHWEGMAN, LUNDBERG & WOESSNER, P.A., P.O. BOX 2938, MINNEAPOLIS, MN, 55402, US

(21) Appl. No.: 10/582,062

(22) PCT Filed: Dec. 8, 2004
(86) PCT No.: PCT/IB2004/052705

§ 371 Date: Jun. 8, 2006

(30) Foreign Application Priority Data
Dec. 10, 2003 (EP) 03104616.2

(51) Int. Cl. H04N 7/167

(52) U.S. Cl. 380/228

(57) ABSTRACT

A video signal distribution system contains a video stream source (10) that produces a data stream with an encrypted video signal, control word information for decrypting the video signal and fee information indicative of fees for viewing respective parts of the video signal. A plurality of video reproduction apparatuses (12) are coupled to a medium (14) to receive the data stream. Each of the video reproduction apparatuses (12) comprises a control word derivation unit (125) for supplying control words derived from the control word information to a video signal decryption device (121). A credit management unit with a credit memory (128) is provided, which enables or disables supply the control words, when the credit memory (128) indicates the availability of more than a threshold amount of credit, and reduces the amount of credit in the credit memory (128) according to the fee information for the part of the video signal for the decoding of which the control words are supplied.

The invention relates to a video signal distribution system for providing conditional access to a video stream, to a method and apparatus for providing conditional access to a video stream, to a method and apparatus for generating an encrypted video stream and to a video stream signal.

PCT patent application WO 98/21852 discusses a conditional access system in accordance with the MPEG-2 standard. The exploitation of such a system is typically subscription based: the system manages a database of subscribers that are entitled to get access to various video programs and sends messages (EMM's—Encryption Management Messages) to the decoders of these subscribers. An EMM is directed at a specific decoder (or more precisely at a smart card in the decoder) and enables the decoder to decode the video streams that the subscriber is entitled to view. Encrypted video data is transmitted together with further messages (ECM's—Encryption Control Messages) that are directed at all decoders and contain encrypted control words that a decoder decrypts, if it is enabled to do so, in order to decode the video data.

Such a subscription based exploitation requires a complex organization: a computer with a subscriber data base must be provided, measures must be taken to protect secret information for the subscribers, hardware must be provided to generate EMM's and transmit them to selected subscribers, subscription fees must be collected and this must be recorded in the database etc.

### SUMMARY OF THE INVENTION

A considerably simplified organization is possible if the decoders themselves manage the entitlement to get access to the video stream, without having to receive subscriber specific information from a central location. This may be realized in a prepaid exploitation model, wherein a decoder contains a smart card (or other secure device) is provided with general viewing credit, which permits the smart card to enable decoding of any program as long as there is sufficient viewing credit, the smart card reducing the viewing credit when the program is decoded upon selection by the viewer. In this case a viewer can buy a smart card with general viewing credit, or an update of the general viewing credit in his or her smart card. No central registration or transmission of EMM's with entitlements is needed.

Moreover, each smart card (or other secure device) is preferably provided with secret information to decrypt the control words for decoding any program. Thus, there is no need to send EMM's with keys addressed to specific smart cards, which also considerably simplifies the organization needed for conditional access.

However, a security risk is introduced if one provides a plurality of freely available smart cards (or other secure device) with a key to decrypt control words of any program at any time and if all programs are broadcast so that their control words can be decrypted with the same key. Persons that desire to get unauthorized access may get the opportunity to compare large numbers of encrypted control words with their decrypted counterparts, which facilitates the recovery of the key. Also, if information about the key leaks from the organization of the operator that encrypts the video information, the entire system will be compromised.

Among others, it is an object of the invention to make it possible to distribute video information providing conditional access without needing a central subscriber database to manage costs.

Among others, it is an object of the invention to make it possible to distribute video information providing conditional access without needing a central subscriber database, and without using the same key to decrypt all control words that are needed for decoding the video information.

Among others, it is an object of the invention to make it possible to distribute video information providing conditional access without needing a central subscriber database, while providing possibilities to counteract leakage of key information.

Among others, it is an object of the invention to make it possible to distribute video information providing conditional access without needing a central subscriber database, while enabling more accurate use of credit for viewing programs of video information.

A video reproduction apparatus according to the invention contains a credit management unit, with a credit memory for storing information about an amount of credit for viewing video information. The memory is preferably part of a detachable smart card (or other secure device) that can be bought as a prepaid card. The video information is included in a stream that also contains fee information to indicate the credit that will be consumed by viewing particular parts of the video information. The reproduction apparatus uses the fee information from the stream to control the extent to which the amount of credit in the credit memory is reduced when the information is decoded, and enables decryption of the control words when there is sufficient credit (typically more than zero credit).

In an embodiment the data stream contains encrypted control words and key information that is accessible to all secure devices to deriving a key to decrypt the encrypted control words. Preferably, both encrypted control words and key information are contained in encryption control messages, and more preferably the key information in an encryption control message serves to decrypt the control word in the same message. Preferably, no EMM's are used at all, or at least no EMM's directed at specific smart cards (or secure devices).

The key may be derived from the key information for example by applying an encryption operation to the key information using a secret key that is stored in the smart card (or other secure device). In a further embodiment different keys may be derived from the same key information by using the key information as a seed to generate a series of keys, e.g. in a pseudo random sequence.

Preferably, the fee information is also contained in the encryption control messages, together with an encrypted control word and optionally key information. Preferably, the fee information from a particular encryption control message is used to reduce the amount of credit when the control word from that particular encryption control message is supplied after having been decrypted. Also preferably, the encryption control messages are authenticated before supplying the decrypted control word. Authentication preferably is preferably performed using authentication information derived from the same key information that is also used to decrypt the control word from the encryption control message.

The reproduction apparatus provides for protection against undesired consumption of credit. In one embodiment the fee information is shown to the users, before and/or during decryption at the expense of credit. In another embodiment expiry of a sleep timer is used to stop consumption of credit (a sleep timer expires a predetermined time interval after a user has last confirmed his or her presence). In another embodiment a credit consumption threshold is used to stop consumption if a threshold is exceeded within a predetermined time interval, e.g. a day. In another embodiment a password is used to enable credit consumption. The password may be required to enable credit consumption overall, or beyond a threshold. Different protection profiles may be supported to allow the user to select how protection against excessive consumption is realized.

These and other objects and advantageous aspects of the invention will be described by reference to the following figures, using non-limiting examples of embodiments.

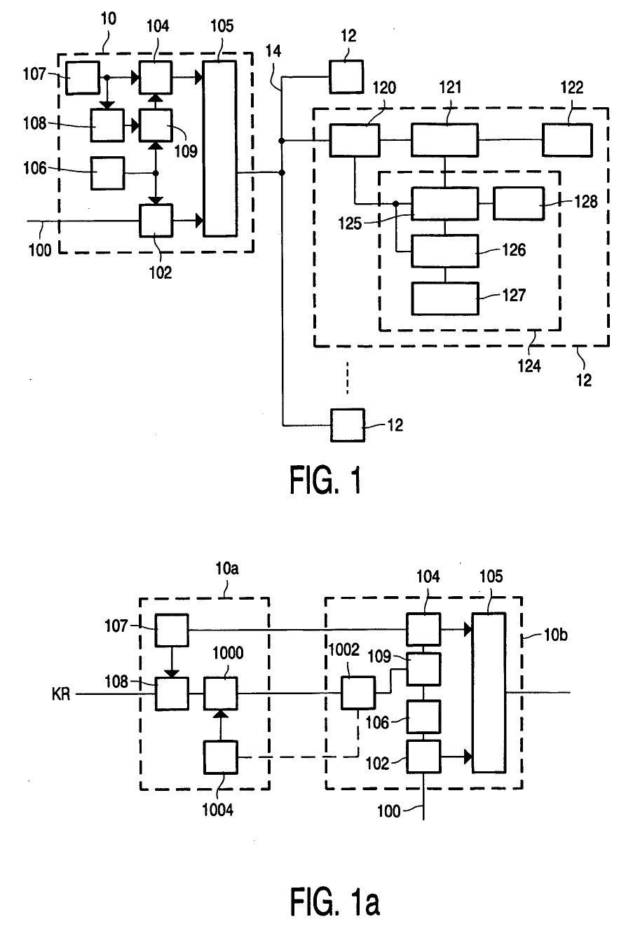

FIG. 1 shows a video distribution system

FIG. 1a shows a video source

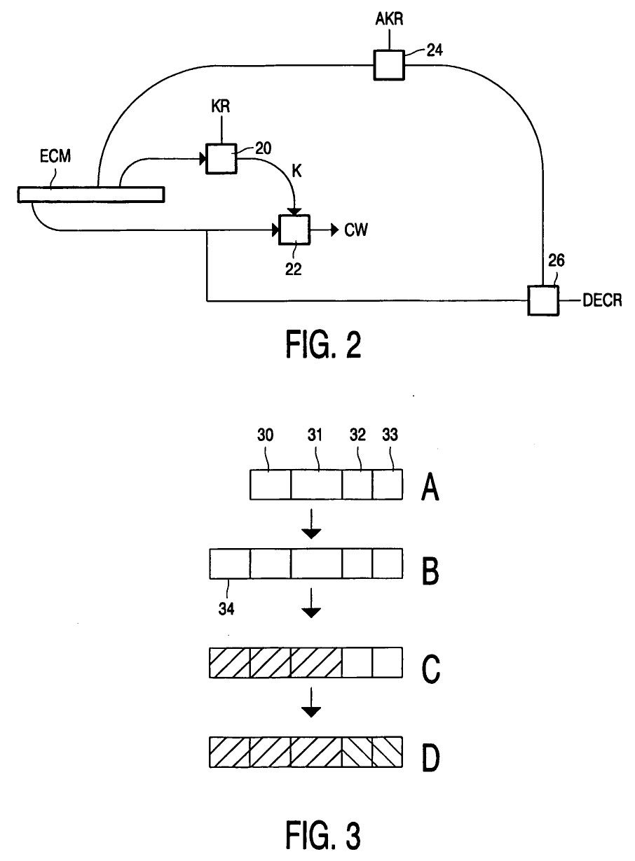

FIG. 2 shows decryption information flow

FIG. 3 illustrates formation of encryption control messages

FIG. 1 shows a video distribution system. The system contains a video stream source 10 and a plurality of video reproduction apparatuses 12 coupled via a distribution medium 14. Medium 14, which is shown symbolically, is for example a cable distribution network or a wireless transmission medium etc.

Video stream source 10 contains a video signal input 100, a video encryption unit 102, an ECM generator 104, a multiplexer 105, a control word source 106, a seed source 107, a key generator 108 and a control word encryption unit 109. Video encryption unit 102 has a video input coupled to video signal input 100. Multiplexer 105 has multiplex inputs coupled to outputs of video encryption unit 102 and ECM generator 104 and an output coupled to medium 14 (not shown, for the sake of clarity is a transmitter that is typically included between multiplexer 105 and medium 14). Control word source 106 has an output for supplying control words, which is coupled to a control word input of video encryption unit 102 and to the ECM generator 104, the latter via control word encryption unit 109. Seed source 107 has a seed output coupled to ECM generator 104 and key generator 108. Key generator 108, which is arranged to use the seed to generate a key, has a key output coupled to control word encryption unit 109.

Video reproduction apparatuses 12 each have substantially the same structure. One of the video reproduction apparatuses 12 is shown in more detail. Video reproduction apparatuses 12 contain a receiver 120, a video decryption unit 121, a further video processing unit 122 and a secure device 124 (e.g. a smart card). Medium 14 is coupled to an input of receiver 120, which has outputs coupled to video decryption unit 121 and secure device 124. Video decryption unit 121 has a video output coupled to further video processing unit 122, which may contain an MPEG decoder and a display unit for displaying decoded video information for example.

Secure device 124 contains a control word decryption unit 125, a key generator 126, a key memory 127 and a credit memory 128. Control word decryption unit 125 has an input coupled to receiver 120 for receiving ECM's from the stream and a control word output coupled to a control word input of video decryption unit 121. Key generator 126 has an input coupled to receiver 120 for receiving ECM's from the stream, an interface to key memory 127 and a key output coupled to control word decryption unit 125. Credit memory 128 is coupled to control word decryption unit 125.

In operation video stream source 10 receives a video signal, encrypts this signal, includes the encrypted signal in a data stream, adding ECM's that contain an encrypted control word for decrypting the encrypted video signal. Typically, the control word is changed every few seconds. Each video reproduction apparatus 12 receives the data stream extracts the encrypted control words from the ECM's and uses them to decrypt the video signal, which may subsequently be used for display.

ECM generator 104 adds fee information to the ECM's. The fee information indicates a size of a fee that must be paid to view the video signal, or preferably that part of the video signal that can be decrypted with the control word in the ECM that contains the fee information. A video reproduction apparatus 12 reads the fee information. When a viewer has selected to view a particular program from the video signal during a particular time interval the video reproduction apparatus 12 decrypts the video information and reduces an amount of credit represented in credit memory 128 in proportion to the fee size. When the amount of credit has been reduced to zero video reproduction apparatus 12 disables decryption of the video information. (A single programmed processor 125 may function both as control word decryption unit and as credit management unit. Instead, of course, a separate credit management unit may be used between the control word decryption unit and the credit memory).

In the system of the embodiment shown in FIG. 1, a user indicates to receiver 120 a program from the stream and (implicitly or explicitly) a time interval during which the program must be decrypted. Receiver 120 supplies the encrypted control words and fee information from the ECMs for the selected program to control word decryption unit 125 during the time interval. Credit memory 128 stores information about an amount of available credit. When it receives the fee information and the encrypted control words, control word decryption unit 125 tests the content of credit memory whether a sufficient amount of credit is available. If so, control word decryption unit 125 decrypts the control word and supplies the decrypted control word to video decryption unit 121 and decreases the amount of credit in proportion to the received fee information.

It will be appreciated that in this way a form a prepay viewing is realized. Secure device 124 is for example a smart card that a user can physically buy at retail shops, in a state where credit memory 128 contains information that represents a predetermined amount of credit. By inserting such a smart card 124 into video reproduction apparatus 12 the user gets the opportunity to view a quantity of video information according to the amount of credit and the fee information included in the video stream. It will moreover be realized that other ways of obtaining credit may be used: for example retail shops may be provided with equipment to “recharge” credit in smart card 124, updating the content of credit memory. Secure device 124 could be similarly recharged via an Internet connection, after an Internet payment, using for example a credit card number. However, this entails a certain added risk of fraud, since the recharging equipment could be forged. As another solution updates of the amount of credit may be sent via medium 14. In this case, update messages that are securely addressed to specific secure devices must be sent by video source 10 and an organization is needed to determine which secure device 124 should receive credit and which not.

Video stream source 10 supplies decryption keys for decrypting the control words to all video decryption apparatuses 12 at the same time. The decryption keys are generated using seed source 107 and key generator 108. ECM generator 104 includes seed information from seed source 107 in the ECM's that are transmitted to video decryption apparatuses 12. Key generator 108 uses the seed information “SEED” to generate a key K, for example by applying an encryption E( ) operation to the seed information

K=E(SEED)

In this example encryption operation E( ) uses a secret root key KR to encrypt the seed information SEED.

Control word source 106 generates the control words, which are used by video encryption unit 102 to encrypt the video information. Control word encryption unit 109 uses key K that has been generated to encrypt the control words and supplies the encrypted control words to ECM generator 104 to for inclusion in the ECM's. Thus, the ECM's contain encrypted control words, as well as seeds SEED used to generate the key to encrypt the control words.

FIG. 1a shows an alternative implementation wherein the video stream source has two components: a trusted third party unit 10a and a head end 10b. Only trusted third party unit 10a has access to root key KR. Trusted third party unit 10a generates the seed and uses the root key to generate the keys K. Trusted third party unit 10a transmits the seed and the keys K (the latter after encryption with a key encryption key KEK by an encryption unit 1000). In the head end the keys K are decrypted by a decryption unit 1002 and used to encrypt the control words generated by control word generator 106 and for inclusion in the ECMs. The key encryption key KEK is provided by a source 1004 in trusted thirty party unit 10a and a corresponding decryption is provided in head end 10b. Trusted third party unit 10a is a separate unit, which is not accessible to the operators of head end 10b. In this way, if information is illegally accessed in head end 10b the root key is not compromised.

In video reproduction apparatuses 12 key generators 126 receive the seed information SEED and use this information to generate the keys K for decrypting the control words. Keys K may be generated for example by encrypting the seed with the same secret root key KR that was used in video stream source. Key generators 126 fetches this key from key memory 127. It will be appreciated that in a prepay system, when no administration is kept of credit that has been issued, so that no secure device specific key messages can be sent from video stream source, large numbers of secure devices must be supplied with the same root key. Preferably the generated keys are kept within secure device 124 to make hacking of the secret root key more difficult.

FIG. 2 illustrates the generation of keys in video reproduction apparatuses 12. Seed information from an ECM is used in a encryption operation 20 with a root key KR to generate a key K, which is used in a decryption operation 22 to decrypt the control word CW from encrypted control word information from the ECM. Similarly, the seed information from the ECM may be used in a encryption operation 24 with an authorisation root key AKR to generate an authorisation key K, which is used in an authorisation operation 26 to enable or disable decryption using information from the ECM.

Preferably, the seed information SEED that is needed to decrypt a control word from an ECM is included in the same ECM. Thus, video data can almost immediately be decrypted once an ECM has been received. However, in another embodiment seed information is included only in a subset of ECM's. In this case, key generator 126 or control word decryption unit 125 store a generated key for repeated use. In this case the seed information from an ECM may apply to control words in later ECM's, without necessarily applying to the control word in the ECM that contains the seed information. However, preferably the seed information is included substantially contemporaneously with the encrypted control words that are decrypted using the seed information. “Contemporaneously”, as used herein refers to difference in position in the stream in terms of the time delay between the time points at which data from the different positions is reproduced during reproduction of the video data, substantially contemporaneously means that the delay, if any, is so small that absence of the video signal during the delay does not bar human understanding of the total reproduced video information.

The seed information may change each time when the control word changes. This reduces the possibilities of hacking the keys. However, without deviating from the invention the seeds may change at different times, for example at a much lower frequency than the control words, for example every few hours, or with a phase offset with respect to changes in control words.

In a further embodiment the same seed information SEED may be used to generate a number of generations of keys in synchronism in video stream source 10 and video reproduction apparatuses 12. A pseudo random generating function R may be applied to the seed for example to generate successive seeds in both video stream source 10 and video reproduction apparatus 12: SEED(n)=R(SEED(n−1)), with SEED(0) being the seed obtained from an ECM. This reduces the number of seeds that need to be sent, but is not indispensable.

Preferably, secure device 124 (e.g. control word decryption unit 125) tests the ECM for signs of tampering before supplying the control words. This may be realized by computing a hash function of the ECM and comparing the result to a reference value, or encrypting the ECM with an authorization key AK and comparing a result derived from this encryption with a reference value provided in the stream. In an embodiment the authorization keys AK that are used for this purpose are computed from the same seed information SEED as the decryption keys, but using an authorization root key AKR that is different from root key KR and is stored in both video stream source 10 and secure device 124.

As a protection against leaks from the organization that manages video stream source 10, the key memory 127 in secure devices 124 of each of the video reproduction apparatuses preferably store a plurality of root keys KR (e.g. four root keys) and optionally also a plurality of authorization root keys AKR. When it is discovered that a key has been compromised, a different one of the stored keys may be used. For this purpose, the ECM's preferably include selection information to indicate the root key KR that should be used to generate the keys K for decrypting the control words. Key generator 126 reads this selection information from the ECM and selects the root key from key memory 127 accordingly. After a root key has been compromised, it is replaced in key generator 108 of video stream source 10, by a key corresponding to the keys stored in secure devices 124 and ECM generator 104 includes the selection information for selecting the new key.

Video stream source 10 has an input for receiving fee information. The fee information may be included for example in the video stream at input 100 and supplied to ECM generator 104 for inclusion in the ECM's. Alternatively files with identification of fees for respective programs and time intervals may be supplied to ECM generator 104 for inclusion.

Preferably, fee information for a program in a time interval is included in each ECM that contains a control word that is needed to decrypt the program in that time interval. Thus, control word decryption unit 125 can reduce the amount of credit upon decryption of each control word directly in response to the fee information in the ECM that contains the control word. The fee size is typically constant during a particular item of content in the video signal, such as a sports game or a motion picture. However, without deviating from the invention a varying fee size may be indicated, e.g. a lower or zero fee size during a leader portion of an item of content, or a higher fee size during selected more interesting portions of the items, such as during the scoring of a goal in a soccer match, a climax of a motion picture etc.

Alternatively, ECM generator may supplement the fee size in an ECM by a specification of the program and time interval to which it applies. In this case control word decryption unit stores this information and reduces the credit according to the fee size when a program is viewed in a time interval according to the fee size received for that program in that time interval (decryption being disabled if no fee size has been received). In this case, not every ECM needs to contain fee information, which saves space, but increases the risk of tampering and possibly a wait time that occurs before a program can be viewed.

In yet another example the fee information may apply to a fee during a time interval as a whole (e.g. the duration of a motion picture, or a sports game) from a program. In this example the control word decryption unit 125 reduces the amount of credit in credit memory 128 once for this time interval and stores information that subsequently enables supply of control words for the program during the entire time interval, without further reduction of the amount of credit. This makes sampled viewing in the time interval as expensive as viewing during the entire interval.

Preferably, several precautions are taken against inadvertent or undesired consumption of credit. In one embodiment, the amount of credit represented in credit memory 128 is reduced only after a signal from a user to do so. In one embodiment, receiver 120 is arranged to receive a command from a user to start a program selection dialog, e.g. via an input for receiving signals from a remote control unit (not shown). In this dialog receiver extracts fee information from the ECM's and causes information derived from this fee information to be displayed by further video processing unit 122, so that the user can understand the amount of credit needed to view one or more programs during certain time intervals. When the user next sends a signal to accept a program in a time interval, or to select an accepted program from a plurality of programs in a time interval, receiver 120 finishes the dialog by sending a signal to secure device 124 to enable reduction of the amount of credit and the supply of decrypted control words for the program in the time interval.

Alternatively, receiver 120 may extract information about the fee size from the ECM's and cause derived information to be displayed together with the decrypted information by further video processing unit 122. In this way reduction of the amount of credit may start without first informing the user, but the user may switch off the program if it proves to expensive. In a further embodiment reduction of the amount of credit may start with a delay after switching on decryption of the program, so that the user can switch off again without incurring a reduction of credit, upon seeing information about the fee. As another example of a protection measure, a sleep timer may be provided that switches off decryption of control word and credit consumption when a viewer has not confirmed his or her presence for a predetermined time interval of for example a half hour. The sleep timer may be reset for example using a signal from a remote control unit, actuation of a user button on video reproduction apparatus 12 etc.

As another precaution video reproduction apparatus 12 may switch off consumption if more than a threshold amount of credit is consumed within a predetermined time interval, in a day for example. Different thresholds may be defined for different programs. As a further example, supply of a password may be required before control word decryption unit 125 starts supplying decrypted control words and reducing the amount of credit. This may be combined with a threshold, e.g. so that consumption of credit is blocked when more than a threshold amount of credit has been consumed in a predetermined time period (say an hour) and no correct password has been entered.

These measures may be implemented in receiver 120, so that receiver 120 blocks the supply of ECM's to secure device 124 when the conditions for not reducing the credit are met. Part or all of these measures may also be implemented in secure device 124, for example in control word decryption unit 125. The conditions under which credit may be consumed may be preset in secure device 124. Thus, when a user buys a smart card for example, he or she can select between different smart cards that provide different protection mechanisms, or thresholds. In particular password checking may be provided in secure device 124 to prevent abuse.

By setting the levels of the thresholds under control of a user, or providing secure devices with preset thresholds different levels of protection against undesired use can be provided. In a further embodiment a plurality of selectable protection profiles are provided, each defining its own combination of conditions under which credit may be consumed. One configuration might specify for example that no credit may be consumed without password, another configuration might specify that no more than a threshold amount of credit may be consumed in a day without a password, yet another configuration might use different thresholds for different programs etc. In this case a user merely needs to indicate a profile, for example by making a selection at receiver 120.

FIG. 3 illustrates a process of generating ECMs. First an original message A is generated, including fields with a cost indicator 30, seed information 31 and first and second control words 32, 33 (typically for decrypting concurrent video information and future video information). Next an authentication field 34 is added to form a message B. In the authentication field information is inserted that is computed from the original message A using a one way (hash) function. Next a semi-encrypted message C is formed wherein general part of message B is encrypted containing the authentication field 34, the cost field 30 and the seed field. Finally a specific part, containing the control words is encrypted with another key, or encryption algorithm to form a message for transmission. In this way, separate access can be given to the general part and the specific part, for management purposes and extracting control words respectively. The authentication information is generated from both parts of the message, so that decryption of both parts is needed to authenticate the message. Alternatively the general part may be left unencrypted. In this authentication still requires decryption of the specific part

Although the invention has been described in terms of a particular embodiment, it will be appreciated that many alternative embodiments are possible. For example, although separate units and memories have been shown in secure device 124, it will be understood that in fact secure device 124 may contain a single non volatile memory and a general purpose processor programmed to perform multiple functions such as credit reduction, control word decryption and key generation. Similarly, various functions of units shown in video stream source 10 may be executed in combination and/or by a suitably programmed processor.

1. A video signal distribution system, the system comprising
a video stream source (10) arranged to generate a video stream and transmit the video stream to a medium (14), the video stream source (10) being arranged to include, in the data stream, an encrypted video signal, control word information for decrypting the video signal and fee information indicative of fees for viewing respective parts of the video signal;
a plurality of video reproduction apparatuses (12) coupled to the medium (14), each of the video reproduction apparatuses (12) comprising
a control word derivation unit (125) with an input coupled to the medium (14) and a control word output, and arranged to supply control words derived from the control word information;
a video signal decryption device (121) having a video input coupled to the medium (14) and a control word input coupled to the control word output, and arranged to decrypt the video information using the control words;
a credit management unit comprising a credit memory (128), and arranged to provide enabling control information to enable or disable supply of the control words, dependent on whether the credit memory (128) indicates the availability of more than a threshold amount of credit, and to reduce the amount of credit in the credit memory (128) according to the fee information for the part of the video signal for the decoding of which the control words are supplied.

2. A video signal distribution system according to claim 1, wherein the control word derivation unit (125) of each of the video reproduction apparatuses (12) has access to secret information in the video reproduction apparatus concerned, wherein the video stream source (10) is arranged to insert key information in the stream accessibly for all of said video reproduction apparatuses simultaneously, the control word derivation unit (125) in each video reproduction apparatus (12) being arranged to generate control word decryption keys from said part of the key information and the secret information, and to use the control word decryption keys to decrypt the control words.

3. A video signal distribution system according to claim 2, wherein the video stream source (10) is arranged to insert encryption control messages (ECM's) in the data stream among the encrypted video signal, at least part of the encryption control messages (ECM's) containing both an encrypted control word and the key information.

4. A video signal distribution system according to claim 3, wherein the key information that is comprised in particular ones of the encryption control messages (ECM's), together with the secret information serves to decrypt the encrypted control word information in the particular ones of the encryption control messages.

5. A video signal distribution system according to claim 2, wherein the stream contains encryption control messages (ECM's) that include a respective one of the encrypted control words and at least part of the fee information, the control word derivation unit (125) being arranged to reduce the amount of credit according to the fee information in a respective one of the encryption control messages (ECM's) in conjunction with supplying a control word decrypted from the respective one of the encryption control messages (ECM's).

6. A video signal distribution system according to claim 1, wherein the control word derivation unit (125) and the credit management unit (128) are contained in an access control device (124) that is detachably coupled to the video signal decryption device (121), so that the credit information is retained in the access control device (124) when the access control device (124) is detached from the video signal decryption device (121).

7. A video signal distribution system according to claim 1, wherein the access control device (124) is a smart card.

8. A video signal reproduction apparatus (12), the apparatus comprising
a reception input (120) for receiving a data stream that contains an encrypted video signal, control word information for decrypting the video signal and fee information indicative of fees for viewing respective parts of the video signal;
a control word derivation unit (125) having an input coupled to the reception input (120) and a control word output, and arranged to supply control words derived from the control word information;
a video signal decryption device (121) having a video input coupled to the reception input (120) and a control word input coupled to the control word output, and arranged to decrypt the video information using the control words;
a credit management unit comprising a credit memory (128), and arranged to provide enabling control information to enable or disable supply of the control words, dependent on whether the credit memory (128) indicates the availability of more than a threshold amount of credit, and to reduce the amount of credit in the credit memory (128) according to the fee information for the part of the video signal for the decoding of which the control words are supplied.

9. A video signal reproduction apparatus according to claim 8, wherein the stream contains encryption control messages (ECM's), at least part of the encryption control messages (ECM's) containing both an encrypted control word and key information, the control word derivation unit (125) being arranged to determine a derived key from key information in a particular one of the encryption control message (ECM's) and secret information in the video signal reproduction apparatus and to decrypt the encrypted control word from that particular one of the encryption control messages (ECM's) with the derived key.

10. A video signal reproduction apparatus according to claim 8, wherein the stream contains encryption control messages (ECM's) that include a respective one of the encrypted control words and a part of the fee information, the control word derivation unit (125) being arranged to reduce the amount of credit according to the part of the fee information in a particular one of the encryption control messages (ECM's) when the control word from that particular one of the encryption control messages (ECM's) is used to decrypt video information.

11. A video signal reproduction apparatus according to claim 10, wherein the control word derivation unit (125) is arranged to authenticate the encryption control messages using authentication information derived using secret information local to a secure device (124) that contains the control word derivation unit (125) and key information included in the encryption control messages (ECM's).

12. A video signal reproduction apparatus according to claim 8, wherein the control word derivation unit (125) has available a plurality of items of secret information, the stream containing item selection information, the control word derivation unit (125) being arranged to generate the derived keys from the key information, using the key information and a particular one of the items of secret information that is selected under control of the item selection information, the derived keys being used to decrypt the encrypted control words.

13. A video signal reproduction apparatus according to claim 8, wherein the control word derivation unit (125) and the credit management unit are contained in an access control device (124) that is detachably coupled to the reception input and the video signal decryption device.

14. A video signal reproduction apparatus according to claim 13, wherein the access control device (124) is a smart card.

15. A video signal reproduction apparatus according to claim 7, comprising a sleep timer, the credit management unit being arranged to stop enabling supply of the control words and reducing the amount of credit when the sleep timer expires.

16. A video signal reproduction apparatus according to claim 15, wherein the credit management unit (125) is arranged to compare a reduction of the amount of credit that has occurred in a predetermined time period with a threshold value and to stop enabling supply of the control words and reducing the amount of credit in said time period when the threshold value is exceeded.

17. A video signal reproduction apparatus according to claim 8, having a user input for receiving password information, the credit management unit being arranged to enable supply of the control words and to reduce the amount of credit conditional upon input of a predetermined password at the user input.

18. A video signal reproduction apparatus according to claim 8, wherein the credit management unit is arranged to execute a selectable one of a plurality of user selectable profiles that specify conditions for enabling supply of the control words and reduction the amount of credit.

19. A video signal reproduction apparatus according to claim 8, comprising a receiver (120) arranged to extract the fee information from the data stream, a display device (122) coupled to the receiver and arranged to display information representing the extracted fee information, prior to enabling reduction of the credit information using the fee information and/or during decryption of the video information associated with the fee information.

20. A method of reproducing a video signal the method comprising
receiving a data stream that contains an encrypted video signal, control word information for decrypting the video signal and fee information indicative of fees for viewing respective parts of the video signal;
using control words to decrypt the video information;
using a smart card (124) to derive the control words from the control word information and to enable derivation and/or use of the control words for decrypting the video information when a credit memory (128) in the smart card (124) indicates the availability of more than a threshold amount of credit, and to reduce the amount of credit in the credit memory according to the fee information for the part of the video signal for the decoding of which the control words are supplied.

21. A method according to claim 20, wherein the stream contains encryption control messages (ECM's), at least part of the encryption control messages (ECM's) containing both an encrypted control word and key information, the method comprising determining, in the smart card (124), a derived key from key information in a particular one of the encryption control messages (ECM's) and secret information in the smart card (124) and to decrypt the encrypted control word from that particular one of the encryption control messages (ECM's) with the derived key.

22. A video stream source apparatus (10), comprising
a video signal encryption unit (102), for encrypting a video signal for decryption with control words and including the encrypted video signal in a data stream;
an encryption control message generator (104), for generating encryption control messages (ECM's) in the data stream, at least part of the encryption control messages (ECM's) comprising both an encrypted control word, key information needed to decrypt the encrypted control words and fee information indicative of a fee for using the encryption control message (ECM).

23. A method of distributing a video signal, the method comprising
generating a data stream that contains an encrypted video signal;
including encryption control messages (ECM's) in the stream and inserting in at least part of the encryption control messages (ECM's) both an encrypted control word and key information needed to decrypt the encrypted control words;
including fee information indicative of fees for using the encryption control messages.
